(19) United States
(12) Patent Application Publication
(10) Pub. No.: US 2003/0068259 A1
(43) Pub. Date: Apr. 10, 2003

(54) Stacked catalytic reactor

(76) Inventors: Shahrokh Etemad, Trumbull, CT (US); Lance L. Smith, North Haven, CT (US)

Correspondence Address: McCormick, Paulding & Huber, City Place II, 185 Asylum Street, Hartford, CT, 06103-3402, US

(21) Appl. No.: 09/953,136

(22) Filed: Sep. 15, 2001

(51) Int. Cl. B01J 35/02; B01J 8/04

(52) U.S. Cl. 422/189; 422/211; 422/188

(57) ABSTRACT

The invention is a stacked catalytic reactor structure employing backside cooling of the catalyst deposited therein wherein the exits from the catalytic passages are interstrafied and proximate to the exits from the backside cooling passages. The structure is designed to oxidize a fluid in the presence of a catalyst and transfer some heat of reaction into a second fluid and isolate the fluid to be reacted from the backside cooling fluid and then combine both fluids.

### FIELD OF THE INVENTION

The present invention is generally directed to a catalytic reactor and is more specifically directed to a catalytic reactor wherein two fluid stream pass through first and second passages therethrough without mixing one with the other and the exits of the passages are positioned to support mixing of the two fluids streams as the streams exit the catalytic reactor.

### BACKGROUND OF THE INVENTION

Catalytic reactors, which employ catalytic oxidation methods, can generate highly exothermic reactions, i.e. reactions that produce a significant quantity of energy in the form of heat. In reactors where a catalyst is positioned on a substrate, this heat can be sufficient to damage the substrate and/or the catalyst.

One strategy developed to protect the substrate and the catalyst is referred to as backside cooling. A backside-cooled substrate generally has two surfaces and permits heat to be conducted therebetween. In most catalytic reactors employing backside cooling, the catalyst is positioned on only one surface of the reactor. Generally during operation, a first fluid to be reacted is passed over the surface with the catalyst and a second fluid, which could be the same as the first fluid, is passed over the other surface.

As heat is generated at the surface on which the catalyst is positioned, the heat is conducted through the substrate from one surface to the other where it is subsequently transferred to the second fluid. The substrate and catalyst are therefore maintained at a temperature below the temperature generated by the heat of reaction.

Some catalytic oxidation methods utilize first and second fluids that are different with the desire to mix these fluids after the first fluid has been oxidized in the presence of the catalyst, thereby forming a first reacted mixture. In particular, certain catalytic reactors have a first fluid that is suitable for the catalytic reaction and a second fluid that is not, e.g. the first fluid is a fuel/oxidant mixture containing the fuel that is to be oxidized to create a reacted mixture and the second fluid is just the oxidant.

One known catalytic oxidation method uses a first fluid that is fuel rich and a second fluid that is an oxidant for the fuel in the first mixture. A rich mixture is a mixture having a ratio, generally referred to as a fuel/air equivalence ratio, greater than one, wherein one represents a stoichiometric mixture. When the first mixture is rich, the reacted mixture produced when the first mixture is passed over the catalyst will be rich. It should be noted that the catalytic reaction is limited by the amount of oxidizer present in the first mixture, so the catalytic reaction will stop when the oxidizer is depleted to a given level that no longer supports catalytic oxidation. However, when the second fluid, which contains oxidant suitable to support oxidation of the fuel in the first fluid, is combined with the reacted mixture, the oxidizer level is once again sufficient for the resumption of combustion. In these types of catalytic reactors, it is important that the reactor structure facilitate the rapid mixing of the reacted mixture with the second fluid.

Based on the foregoing, it is the general object of the present invention to provide a catalytic reactor that overcomes the above-identified problems and drawbacks of prior art reactors.

### SUMMARY OF THE INVENTION

The stacked catalytic reactor of the present invention is comprised of a plurality of housings each defining a cavity having an entrance in fluid communication therewith and a plurality of first passages each in fluid communication with the cavity and each having an exit. The plurality of housings are placed adjacent one to the other such that a second passage is defined between successive housings. Each second passage has an exit. The first passage exits and the second passage exits are interstratified and proximate one to the other. In addition, a catalyst is positioned on at least one surface that defines the first passages.

The structure of the stacked catalytic reactor allows a first fluid to enter into the cavity and pass through the first passages while simultaneously a second fluid passes through the second passages. The second fluid backside cools the first passage. By having multiple housings with the exits of the first and second passages interstratified and proximate, the first fluid and the second fluid are subdivided into smaller flows that will begin mixing immediately upon exiting the first and second exits and will mix more rapidly than two bulk flows. The structure also permits the entrances of the cavities to be in fluid communication thereby permitting a single fluid flow to be subdivided and enter each cavity.

Preferably, each housing is made from a first plate and a second plate, with the first plate being contoured, e.g. corrugated, in the region of the first passages and flat in the area of the cavity. The second plate, which is similarly contoured, is then placed next to the first plate and the edges sealed thereby defining the cavity and the first passages. An entrance in then made into each cavity. The entrance can be made through either plate or defined by the first plate in cooperation with the second plate. The use of contours in the plates is not required as wall structures could also be used.

The housings are then placed adjacent one another such that a first plate of one housing is in contact with the second plate of the adjacent housing. The contours of the first plate of one housing in cooperation with the contours of the second plate of the adjacent housing define the second passages. As the contours of the first plate define at least a portion of both the exits of the first passages and the exits of the second passages, the exits are by design are interstratified and proximate. It is not required that the passages, first or second, be isolated one from the other, leakage between first, or second, passages is permissible.

The catalyst is application specific and can be positioned on either the first plate and/or the second plate in the area of the first passages. If backside cooling of the catalyst is required, the catalyst must be positioned within the first passage such that it is on a surface that is backside cooled. A surface that is backside cooled is a surface that defines a portion of a first channel with an opposing surface that defines a portion of second passage. It should be recognized that if the housings are stacked with the first side of one housing being adjacent to the second side of the adjacent housing the surfaces that define the first passages on the boundaries will not be completely backside cooled unless additional structure is added. Positioning of the catalyst can be by deposition, alloying, or any other standard means.

The entrances of the housing can be in fluid communication one with the other. This is accomplished by connecting the entrances to a common pipe. It is also possible to have entrance and exit combinations, such that a fluid flows through an exit of one cavity into an entrance of another cavity. It should be realized that there are numerous structures that can be used to place one cavity in fluid communication with another and the invention should not be limited by the structure depicted herein.

The passages, first or second, can be straight or have tortuosity. Tortuosity meaning that the ratio of the length of the passage to the shortest possible length, i.e. straight, is greater than one. Shapes such as serpentine, zigzag and herringbone that would yield a tortuosity greater than one are considered within the scope of the invention. The passages can also be interconnected permitting mixing, e.g. a fluid enters one passage but exits through another. If tortuous passages are used, the contours must position the first and second passage exits so that the exits are interstratified and proximate.

### BRIEF DESCRIPTION OF THE DRAWINGS

The following drawings are provided to illustrate the invention:

FIG. 1 is an exploded schematic view of a stacked catalytic reactor of the present invention;

FIG. 2 is a partial cross sectional view of the stacked catalytic reactor of in FIG. 1 taken along line 2-2;

FIG. 3 is a partial cross sectional view of the stacked catalytic reactor of in FIG. 1 taken along line 3-3;

FIG. 4 is a cross sectional view of the stacked catalytic reactor of in FIG. 1 taken along line 4-4;

FIG. 5 is a partial cross sectional view of the stacked catalytic reactor of in FIG. 1 taken along line 5-5; and

FIG. 6 is a schematic cross sectional of a portion of a housing for use in the stacked catalytic reactor of the present of the present invention.

### DETAILED DESCRIPTION

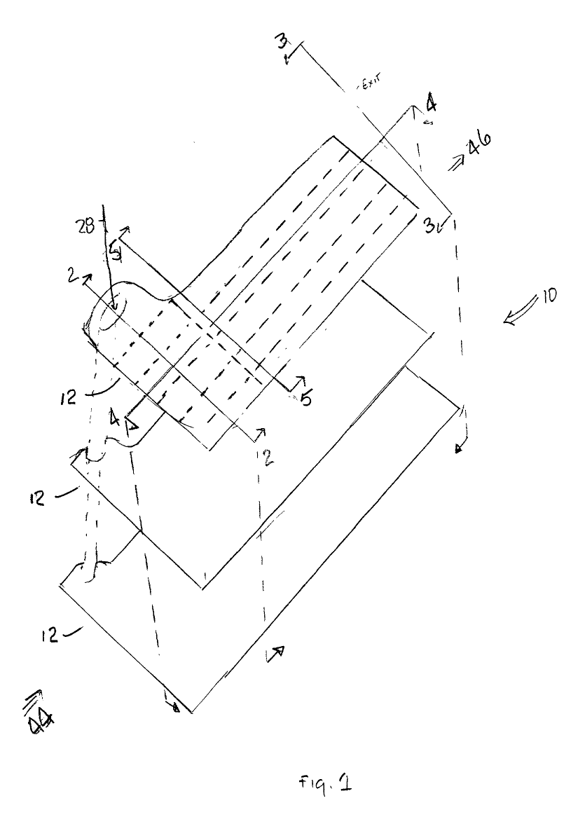

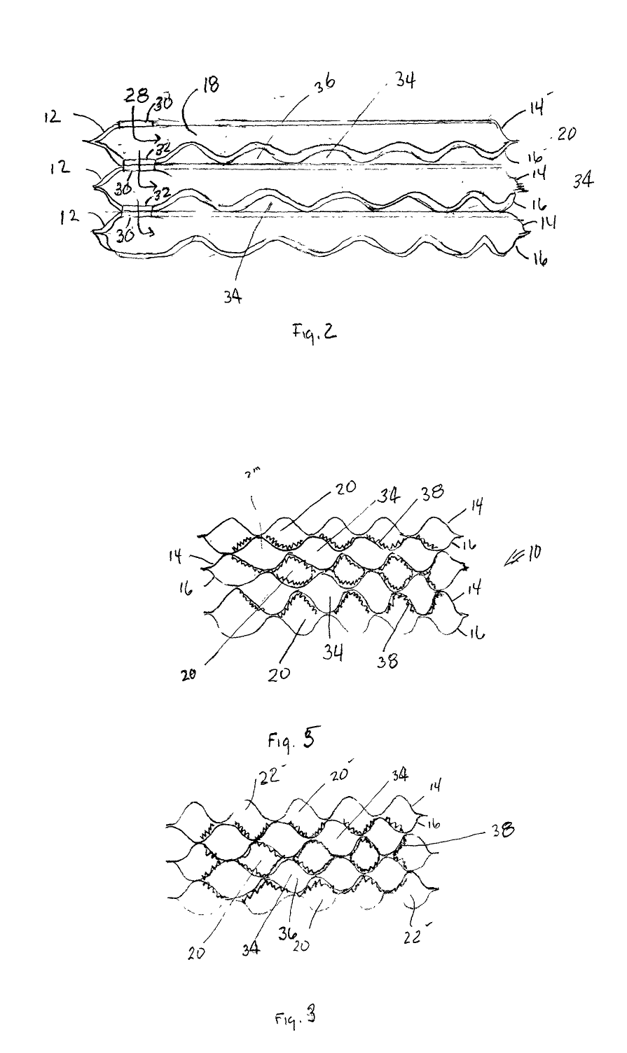

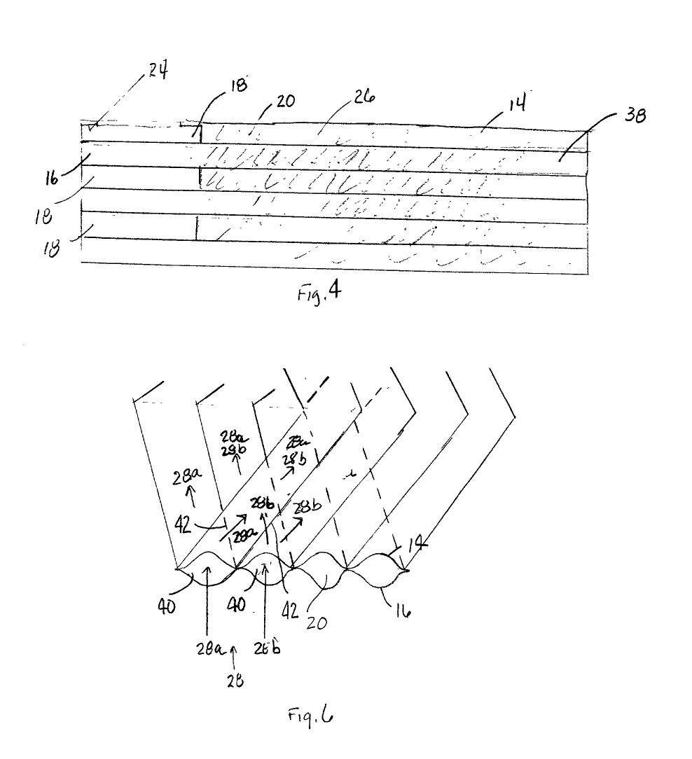

As shown in FIG. 1, a stacked catalytic reactor generally denoted by reference number 10 comprises a plurality of housings 12. Each housing 12 is positioned adjacent one to the other. Continuing with FIG. 2, each housing 12 is comprised of a first plate 14 and a second plate 16. The first plate 14 and second plate 16 are corrugated and cooperate to define cavity 18 and first passages 20 (See FIG. 5), each having an exit 22 (See FIG. 3). Referring to FIG. 4, the first plate 14 has a flat section 24 in the area of the cavity 18 and corrugations 26 in the area of the first passages 20. The second plate 16 is completely corrugated.

Returning to FIG. 2, the edges where the first plate 14 and the second plate 16 meet are sealed by a suitable method such as welding, gluing, and/or crimping. The cavity 18 is in fluid communication with the first passages 20 such that a fluid 28 that enters a cavity 18 through an entrance 30 travels into first passages 20. The cavities 18 are in fluid communication by a series of interconnected entrances 30 and exits 32. As depicted the relevant entrances 30 and exits 32 are positioned immediately adjacent one an other, but this is not a requirement of the invention as a duct could be used. It should also not be considered a limitation of the invention that a series of interconnected entrances and exits are used as piping could be used to interconnect only the entrances. As those skilled the art will appreciate, there are numerous ways to have fluid communication between the cavities 18.

When the housings 12 are stacked adjacent one another, the second plate 16 of one housing 12 cooperates with the first plate 14 of the adjacent housing 12 to define second passages 34, each having an exit 36 (See FIG. 3). As corrugated first plates 14 and second plates 16 have similar, if not identical, corrugations, first passages 20 and second passages 34 are generally similar.

As shown in FIG. 5, the first passages 20 are depicted as generally discrete, i.e. there is little or no flow between first passages, this, however, is not a requirement of the invention as gaps could be provided. A catalyst 38 is positioned within first passages 20. The catalyst 38 is positioned on the first plate 14 and the second plate 16 such that the catalyst 38 is backside cooled. More specifically, the catalyst 38 is positioned on a plate that has a surface that defines a portion of the first passage 20 and another surface that defines a portion of a second passage 34. Where the anticipated catalytic reaction is such that backside cooling of the plates or the catalyst is not required, the catalyst 38 can be positioned on any surface defining a first passage 20. It should be noted that first passages 20 located on the perimeter of stacked catalytic reactor 10 are not completely coated with catalyst when backside cooling of the catalyst is required.

FIG. 3 shows that the exits 22 of the first passages 20 and the exits 36 of the second passages 34 are interstratified and proximate one to the other. In operation, as shown in FIG. 1 and FIG. 2, a bulk first fluid 28 enters cavities 18 and is subdivided into multiple flow streams by first passages 20. Simultaneously, a bulk second fluid 44 is subdivided into multiple flow streams by second passages 34. These two flow streams combine upon exiting first passages 20 and second passages 36 to form third fluid 46. The first and second passages, 20 and 36, respectively, are sized to permit rapid mixing, i.e. the passage exits act as jets.

While the passage have been depicted as discrete and straight, the passages can have other shapes, i.e. be more tortuous. “Tortuosity” is a common term for quantifying the length of a passage. More specifically, tortuosity is the ratio of the length of the flow path to the length of the shortest possible flow path, i.e. the straight flow path. Therefore, if the flow path is straight the tortuosity is one. Flow paths such as curved, zigzag, serpentine and herringbone, have tortuosities greater than one can also be used.

The passages can also allowing intermixing. A sample structure that combines tortuosity and intermixing can be created by corrugating the first plate 14 and the second plate 16 in for example a herringbone pattern with the herringbone patterns being mirror images of each other, as shown in FIG. 6. These passages permit a fluid entering a passage through a given passage entrance 40 to mix with fluid entering through another passage entrance 40. More specifically, a first fluid 28 is subdivided into flows 28a and 28b upon encountering the entrances 40 to first passages 20. A portion of flow 28a and flow 28b subsequently mix as a result of opening 42. Opening 42 is created by the intersecting corrugations of the first plate 14 and the second plate 16. If the herringbone pattern is continued, this ability to mix will continue throughout the catalytic reactor 10.

While preferred embodiments have been shown and described, various modification and substitutions may be made without departing from the spirit and scope of the invention. Specifically, the first and second passages have been shown as being defined by a first plate and second plate that have been corrugated. Other structures such as walls or partitions could be used to define the passages. Accordingly, it is understood that the present invention has been described by way of example, and not by limitation.

What is claimed is:

1. A stacked catalytic reactor comprising:
a plurality of housings each defining a cavity having an entrance in fluid communication therewith, and a plurality of first passages each in fluid communication with the cavity, each first passage having a first exit;
the plurality of housings being positioned adjacent one to the other and defining at least one second passage between successive housings, each second passage having a second exit, the first exits and the second exits being interstratified and proximate one to the other; and
a catalyst positioned on at least a portion of one surface defining the first passages.

2. The stacked catalytic reactor of claim 1 wherein the entrances to the cavities are in fluid communication with each other.

3. The stacked catalytic reactor of claim 1 wherein each housing is comprised of a first plate and a second plate, the first plate being contoured to define the first passages and the cavity.

4. The stacked catalytic reactor of claim 3 wherein the plurality of housings are arranged so that the first plate of one housing is positioned next to the second plate of the adjacent housing, the adjacent first and second plates cooperating to define a plurality of second passages.

5. The stacked catalytic reactor of claim 4 wherein the second plate is contoured.

6. The stacked catalytic reactor of claim 5 wherein the first plate and the second plate of a housing cooperate to make the first passages tortuous.

7. The stacked catalytic reactor of claim 6 wherein the first plate and adjacent second plate cooperate to make the second passages tortuous.

8. The stacked catalytic reactor of claim 1 wherein the first passages are non-linear.

9. The stacked catalytic reactor of claim 1 wherein the first passages are isolated one from the other.

10. The stacked catalytic reactor of claim 1 wherein there are at least two second passages.

11. The stacked catalytic reactor of claim 10 wherein the at least two second passages are isolated one from the other.

12. The stacked catalytic reactor of claim 10 wherein the first passages are isolated one from the other.

13. The stacked catalytic reactor of claim 10 wherein the second passages are tortuous.

14. The stacked catalytic reactor of claim 1 wherein the first passages are tortuous.
